(19) United States
(12) Patent Application Publication
(10) Pub. No.: US 2011/0192259 A1
(43) Pub. Date: Aug. 11, 2011

(54) WRENCH

(75) Inventors: Dave Stauss, Fort Wayne, IN (US); Joel Nichols, Columbia City, IN (US); Jeff Mateer, Fort Wayne, IN (US)

(73) Assignee: APOLLO DESIGN TECHNOLOGY, INC., Fort Wayne, IN (US)

(21) Appl. No.: 12/947,399

(22) Filed: Nov. 16, 2010

Related U.S. Application Data
(60) Provisional application No. 61/261,596, filed on Nov. 16, 2009.

(51) Int. Cl. B25B 13/16; B25B 23/00

(52) U.S. Cl. 81/170; 81/184

(57) ABSTRACT

A wrench including an adjustable portion configured for use on nuts and bolts of various sizes and a fixed portion including a number of fixed sockets configured for cooperation with specific predetermined sizes of bolt heads. The adjustable portion including a movable jaw configured for slidable engagement with a fixed jaw.

### CROSS REFERENCE TO RELATED APPLICATIONS

The present application claims the benefit of U.S. Provisional Patent Application Ser. No. 61/261,596 filed on Nov. 16, 2009, which is fully incorporated by reference herein.

### BACKGROUND AND SUMMARY

The present disclosure is directed to a wrench for use with theatrical lighting fixtures. In particular, the wrench of the present disclosure includes an adjustable portion configured for use on nuts and bolts of various sizes and a fixed portion configured for cooperation with specific aspects of a theatrical lighting fixture. Specifically, the fixed portion includes a number of sockets configured to cooperate with bolt heads of predetermined size and shape.

Theatrical lighting fixtures are typically installed using a clamp designed specifically for this purpose. These clamps typically have three different sized bolts used to fasten the lighting fixture. All three bolts must be loosened and tightened when installing a lighting fixture. It is not unusual to have an installation requiring hundreds of lighting fixtures. This creates a repetitious sequence of settings on an adjustable wrench.

In addition, bolts of other sizes may be encountered during the installation. Two wrenches must be purchased and carried at all times during an installation.

The wrench of the present disclosure combines the function of a common adjustable wrench with specialized sockets required to manipulate the bolts found on a lighting fixture clamp. The wrench of the present disclosure may be configured to clamp onto the handle of an adjustable wrench, or alternatively be integrally formed into the handle. The present disclosure includes three sockets that fit the bolts found on lighting clamps. These features save money and time.

One aspect of the present disclosure includes a wrench having a body, an adjustable portion, and a fixed portion. The adjustable portion includes a fixed jaw integrally formed into the body, a movable jaw slidably engaged with the fixed jaw, and a thumb screw configured to engage the movable jaw. Rotation of the thumb screw in a first direction drives the movable jaw outwardly relative to the fixed jaw and rotation of the thumb screw in a second direction opposite to the first direction drives the movable jaw outwardly relative to the fixed jaw. The fixed portion includes a plurality of sockets of predetermined configuration. The handle portion is integrally formed in the body and disposed between the adjustable portion and the fixed portion.

Another aspect of the present disclosure includes a tool configured for attachment to a handle of an adjustable wrench. The tool includes a notch at one end, the notch being configured to form a plurality of sockets, and a fastener configured to cooperate with the handle of the adjustable wrench to attach the tool.

### BRIEF DESCRIPTION OF THE DRAWINGS

The present disclosure will be described hereafter with reference to the attached drawings which are given as a non-limiting example only, in which:

FIG. 1 is a plan view of an embodiment of the wrench of the present disclosure;

FIG. 2 is section view taken at line 2-2 in FIG. 1;

FIG. 3 is a plan view of an alternative embodiment of a tool of the present disclosure;

FIG. 4. illustrates a typical theatrical lighting fixture; and

FIG. 5 is a detailed view of a claim on the theatrical lighting fixture of FIG. 4.

### DETAILED DESCRIPTION

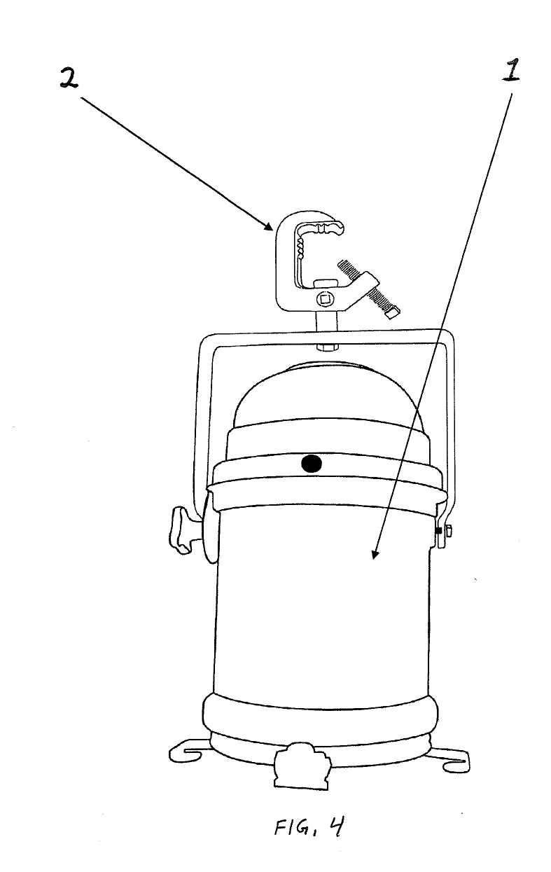

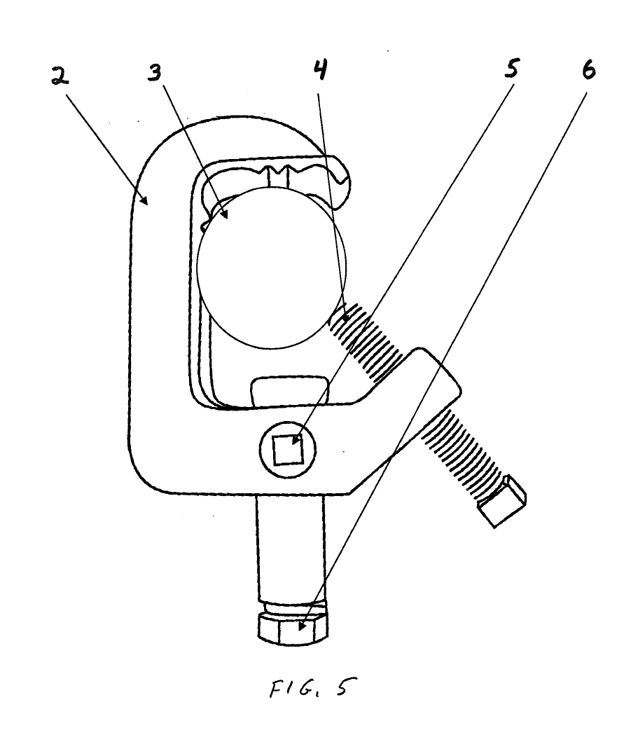

Theatrical lighting fixtures 1, as shown in FIG. 4 are typically installed above a stage or performance area by attaching with a clamp 2 to a support such as a truss, support pipe, frame, or the like. For example, as shown in FIG. 5, a common clamp 2 for theatrical lighting fixtures is configured in the shape of a C for disposition around a support 3. The clamp 2 includes three bolts 4, 5, 6. The first bolt 4 is configured to secure the clamp 2 to support 3 when fully tightened and is typically a ½ inch bolt with a ½ inch square head. Alternatively, when bolt 4 is loosened, the clamp 2 may be removed from the support 3.

The second bolt 5, when fully tightened is configured to prevent the lighting fixture 1 from rotating from side to side. Thus, when bolt 5 is disengaged, lighting fixture 1 may be rotated to a predetermined position, then fixed in place by tightening bolt 5. The second bolt 5 is typically a 5/16 inch bolt with a 5/16 inch square head.

The third bolt 6 attaches lighting fixture 1 to the clamp 2. The third bolt 6 is typically a ½ inch bolt with a ¾ inch hex head.

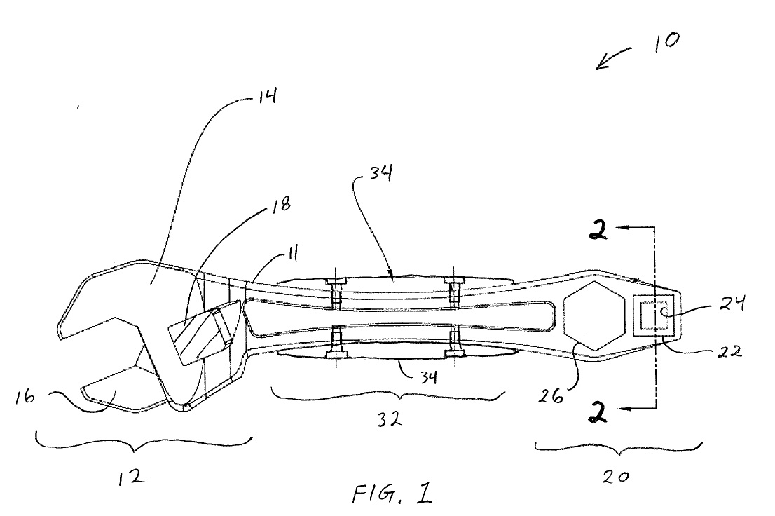

The present disclosure is directed to a wrench 10 configured for use on bolts 4, 5, 6, commonly found on theatrical lighting fixtures as well as other nuts and bolts of various sizes. Referring to FIG. 1, wrench 10 includes a body 11, an adjustable portion 12 and a fixed portion 20. Adjustable portion 12 includes a fixed jaw 14 integrally formed into body 11 and a movable jaw 16. The movable jaw 16 is slidably engaged with the fixed jaw 14. Movable jaw may be configured to engage a threaded thumb screw 18, the threads configured to engage a rack on movable jaw 16 such that rotation of thumb screw 18 in a first direction drives movable jaw 16 outwardly relative to fixed jaw 14 and rotation of thumb screw 18 in a second direction, opposite the first direction, drives movable jaw 16 inwardly relative to fixed jaw 14.

Fixed portion 20 includes a number of sockets sized and configured to accommodate predetermined bolt sizes, for example bolt sizes common to theatrical lighting fixtures. In the exemplary embodiment of FIG. 1, fixed portion 20 includes a first socket 22, a second socket 24, and a third socket 26. First socket 22 is configured to cooperate with a ½ inch square bolt head as is found on bolt 4 (shown in FIG. 5). Second socket 24 is configured to cooperate with a 5/16 inch square bolt head as is found on bolt 5 (shown in FIG. 5). Third socket 26 is configured to cooperate with a ¾ inch hexagonal bolt head as is found on bolt 6 (shown in FIG. 5).

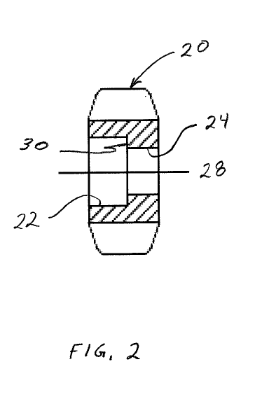

Referring now to FIG. 2, first socket 22 and second socket 24 are formed in fixed portion 20, wherein first socket 22 may be disposed on one side of fixed portion 20 and second socket 24 may be disposed on an opposite side of fixed portion 20. In the exemplary embodiment, first socket 22 and second socket are formed collinearly about a common axis 28 forming an aperture through fixed portion 20, the aperture having a step 30 at the interface of the first socket 22 and the second socket 24. Also in the exemplary embodiment, third socket 26 is spaced apart from the first socket 22 and the second socket 24. Third socket 26 may be configured to form an aperture through fixed portion 20, or alternatively may be configured to form a recess in fixed portion 20. Although disclosed for illustrative purposes, it should be apparent that any suitable configuration of sockets 22, 24, 26 in fixed portion 20 may be equally acceptable to one skilled in the art.

Referring again to FIG. 1, the wrench 10 of the present disclosure may also include a handle portion 32 configured for grasping by a user. Handle portion 32 may also include hand grips 34.

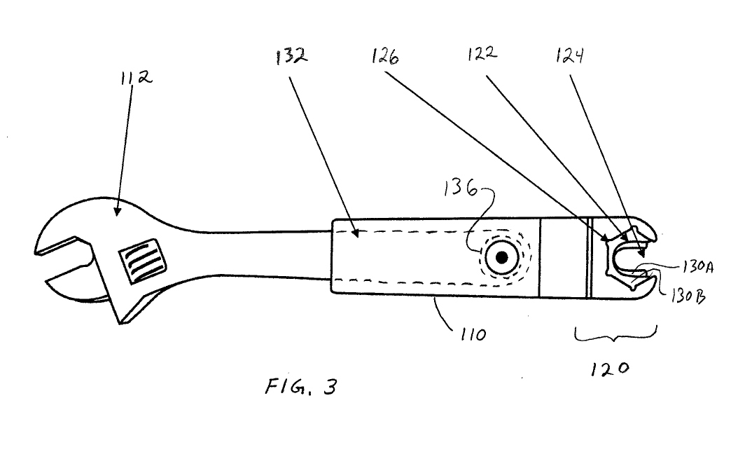

Referring now to FIG. 3, an alternative embodiment of the wrench of the present disclosure may be configured as a tool 110 including a fixed portion 120. The tool 110 being configured for attachment to a standard adjustable wrench 112. Fixed portion 120 includes a first socket 122, a second socket 124, and a third socket 126. First socket 122 is configured to cooperate with a ½ inch square bolt head. Second socket 124 is configured to cooperate with a 5/16 inch square bolt head. Third socket 26 is configured to cooperate with a ¾ inch hexagonal bolt head.

In this exemplary embodiment, the first socket 122, the second socket 124, and the third socket 126 are formed collinearly forming a notch at one end of attachment 110. The notch includes a first step 130A at the interface of the first socket 122 and the second socket 124. The notch also includes a second step 130B at the interface the interface of the first socket 122 and the third socket 126.

A typical adjustable wrench 112 includes a handle portion 132 having a circular aperture 136 at one end. Tool 110 is configured to cooperate with and be secured to handle portion 132 by a fastener 138 such as a screw or bolt extending through aperture 136 and secured with a nut for removable attachment. Alternatively a rivet or other permanent fastener may be used for permanent attachment.

While preferred embodiments of the present invention are shown and described, it is envisioned that those skilled in the art may devise various modifications of the present invention without departing from the spirit and scope of the appended claims.

We claim:

1. A wrench comprising:
a body;
an adjustable portion including
a fixed jaw integrally formed into the body,
a movable jaw slidably engaged with the fixed jaw, and
a thumb screw configured to engage the movable jaw, wherein rotation of the thumb screw in a first direction drives the movable jaw outwardly relative to the fixed jaw and wherein rotation of the thumb screw in a second direction opposite to the first direction drives the movable jaw inwardly relative to the fixed jaw; and
a fixed portion including
a plurality of sockets of predetermined configuration; and
a handle portion, integrally formed in the body and disposed between the adjustable portion and the fixed portion.

2. The wrench of claim 1 wherein the plurality of sockets comprises:
a first socket and a second socket formed collinearly about a common axis, wherein the first socket is disposed on a first side of the fixed portion and the second socket is disposed on a second side of the fixed portion.

3. The wrench of claim 2 further comprising a third socket spaced apart from the first socket and the second socket.

4. The wrench of claim 2 wherein the first socket and the second socket are each configured as a square of different sizes.

5. The wrench of claim 3 wherein the third socket is configured as a hexagon.

6. The wrench of claim 1 further including a grip attached to the handle portion.

7. A wrench comprising:
a body including
an adjustable portion,
a fixed portion including a plurality of sockets of predetermined configuration, and
a handle portion, integrally formed in the body.

8. The wrench of claim 7 wherein the adjustable portion comprises
a fixed jaw integrally formed into the body;
a movable jaw slidably engaged with the fixed jaw; and
a thumb screw configured to engage the movable jaw, wherein rotation of the thumb screw in a first direction drives the movable jaw outwardly relative to the fixed jaw and wherein rotation of the thumb screw in a second direction opposite to the first direction drives the movable jaw inwardly relative to the fixed jaw.

9. The wrench of claim 7 wherein the plurality of sockets comprises a first socket, a second socket and a third socket.

10. The wrench of claim 9 wherein the first socket and the second socket are formed collinearly about a common axis, wherein the first socket is disposed on a first side of the fixed portion and the second socket is disposed on a second side of the fixed portion.

11. The wrench of claim 9 wherein the third socket is spaced apart from the first socket and the second socket.

12. The wrench of claim 9 wherein the first socket and the second socket are each configured as a square of different sizes.

13. The wrench of claim 7 further comprising a grip attached to the handle portion.

14. A tool configured for attachment to a handle of an adjustable wrench, the tool comprising:
a plurality of sockets at one end of the tool; and
a fastener configured to cooperate with the handle of the adjustable wrench to attach the tool.

15. The tool of claim 14 wherein the plurality of sockets comprises a first socket, a second socket, and a third socket.

16. The tool of claim 15 wherein the first socket is configured to cooperate with a ½ inch square bolt head.

17. The tool of claim 15 wherein the second socket is configured to cooperate with a 5/16 inch square bolt head.

18. The tool of claim 15 wherein the third socket is configured to cooperate with a ¾ inch hexagonal bolt head.

19. The tool of claim 15 wherein the plurality of sockets is configured collinearly thereby forming a notch.
